(19) United States
(12) Patent Application Publication
(10) Pub. No.: US 2020/0103783 A1
(43) Pub. Date: Apr. 2, 2020

(54) LIGHT EMISSION CONTROL DEVICE AND IMAGE FORMING APPARATUS

(71) Applicant: TOSHIBA TEC KABUSHIKI KAISHA, Tokyo (JP)

(72) Inventor: Koji TANIMOTO, Kannami Tagata Shizuoka (JP)

(73) Assignee: TOSHIBA TEC KABUSHIKI KAISHA, Tokyo (JP)

(21) Appl. No.: 16/568,558

(22) Filed: Sep. 12, 2019

(30) Foreign Application Priority Data
Oct. 2, 2018 (JP) 2018-187584

(51) Int. Cl. G03G 15/043

(52) U.S. Cl. CPC G03G 15/043

(57) ABSTRACT

A light emission control device includes an acquisition unit and a processor. The acquisition unit is configured to acquire image data. The processor is configured to (i) select a respective light emission region from a plurality of light emission regions to be shifted in a direction of a light-emitting element array within a maximum light emission region corresponding to the light-emitting element array of a print head in accordance with printing of images in a unit of a predetermined number of prints based on the image data, and (ii) control light emission of the respective light emission region based on the image data.

### CROSS-REFERENCE TO RELATED APPLICATION

This application is based upon and claims the benefit of priority from Japanese Patent Application No. 2018-187584, filed on Oct. 2, 2018, the entire contents of which are incorporated herein by reference.

### FIELD

Embodiments described herein relate generally to a light emission control device and an image forming apparatus.

### BACKGROUND

There are known image forming apparatuses such as printers, printmachines, multi-functional peripherals (MFPs) using electrophotographic processes. As exposure units of such image forming apparatuses, there are known two systems called a laser optical system (LSU: laser scan unit) and a print head (solid-state head). In the laser optical system, a photosensitive drum is exposed by a laser beam scanned by a polygon mirror. In the print head, a photosensitive drum is exposed by light output by a plurality of light-emitting elements such as light emitting diodes (LEDs).

Since the polygon mirror is required to be rotated at a high speed in the laser optical system, a lot of energy is consumed and operation sound occurs when an image is formed. Since a mechanism for scanning laser light and a lens group for imaging the scanned light on a photosensitive drum are necessary, these units tend to be large.

One print head can be miniaturized since the print head has a structure in which light output from the plurality of light-emitting elements is imaged on the photosensitive drum using a small lens called a rod lens array that forms an erect image. Since there is no movable unit, consumed energy is small and an exposure unit is quiet. As the print head, a print head using an organic light emitting diode (OLED) is developed other than a print head using an LED (a print head in which LED chips are arrayed).

In the print head using the LED, LED chips are generally arrayed on a printed substrate. For the organic electroluminescence (EL), organic ELs can be collectively formed on a substrate using a mask to array light-emitting elements with high precision. For example, there is known an example in which a plurality of light-emitting elements including organic ELs is formed on a glass substrate.

A plurality of light-emitting elements of a print head correspond to one line in a main scanning direction and each light-emitting element emits light based on pixel information read from a page memory.

A light emission timing of each light-emitting element of the print head is controlled based on pixel information of image data. Before an imaging forming apparatus is shipped, an output (an amount of light) of each light-emitting element of a print head is adjusted to be constant.

The output (an amount of light) of a light-emitting element is known to decrease over a light emission time. In particular, when the same image is consecutively printed or the same-size images are consecutively printed, the output of a specific light-emitting element decreases. The decrease in the output of the specific light-emitting element may be a cause for conspicuousness of density irregularity. Accordingly, there is a need for a technique for suppressing the decrease in the output of the specific light-emitting element and reducing the conspicuousness of the density irregularity.

### DESCRIPTION OF THE DRAWINGS

FIG. 1 is a diagram illustrating an example of a relation between a photosensitive drum and a print head according to an embodiment;

FIG. 2 is a diagram illustrating an example of the print head according to the embodiment and illustrates first and second light-emitting element arrays, first and second DRV circuit arrays, an IC, and a connector disposed on a transparent substrate;

FIG. 3 is a diagram illustrating an example of the print head (two-line head) and illustrates a light-emitting element array on the transparent substrate;

FIG. 4 is a diagram illustrating a cross-section of an image forming apparatus which is an application example of the print head;

FIG. 5 is a diagram illustrating an example of a control block;

FIG. 6 is a diagram illustrating an example of a relation between a light emission region (a main scanning width) and an image formation region;

FIG. 7 is a diagram illustrating an example of image shift by the image forming apparatus;

FIG. 8 is an explanatory diagram illustrating a concept of consecutive shifting by the image forming apparatus;

FIG. 9 is an explanatory diagram illustrating a concept of random shifting by the image forming apparatus;

FIG. 10 is a flowchart illustrating a setting example of shifting by the image forming apparatus;

FIG. 11 is a flowchart illustrating an example of first shifting by the image forming apparatus;

FIG. 12 is a flowchart illustrating an example of second shifting by the image forming apparatus;

FIG. 13 is a flowchart illustrating an example of third shifting by the image forming apparatus;

FIG. 14 is a flowchart illustrating an example of consecutive shifting by the image forming apparatus;

FIG. 15 is a flowchart illustrating an example of random shifting by the image forming apparatus;

FIG. 16 is a diagram illustrating an example of a relation between a cumulative light emission time and an amount of light in each light-emitting element of the print head; and

FIG. 17 is a diagram illustrating a comparison example between an influence on density irregularity when printing multiple prints of the same image or same-size images without shifting and an influence on density irregularity when printing multiple prints of the same image or same-size images with shifting.

### DETAILED DESCRIPTION

Embodiments provide a light emission control device and an image forming apparatus capable of suppressing a decrease in the output of a specific light-emitting element and reducing conspicuousness of density irregularity.

In general, according to one embodiment, a light emission control device includes an acquisition unit and a processor. The acquisition unit acquires image data. The processor selects one light emission region from a plurality of light emission regions shifted in a direction of a light-emitting element array within a maximum light emission region corresponding to the light-emitting element array of a print head, in accordance with printing of images in a unit of predetermined prints based on the image data, and controls light emission of the selected light emission region based on the image data.

Hereinafter, embodiments will be described with reference to the drawings.

FIG. 1 is a diagram illustrating an example of a positional relation between a photosensitive drum and a print head applied to an image forming apparatus according to an embodiment. For example, an image forming apparatus such as a printer, a printmachine, or a multi-functional peripheral includes a photosensitive drum 111 illustrated in FIG. 1 and a print head 1 is disposed to face the photosensitive drum 111.

The photosensitive drum 111 rotates in a direction indicated by an arrow illustrated in FIG. 1. The rotational direction is referred to as a sub-scanning direction SD. The photosensitive drum 111 is evenly charged by a charger and is exposed with light from the print head 1 to lower the potential of the exposed portion. That is, an electrostatic latent image can be formed on the photosensitive drum 111 by controlling light emission and non-light emission of the print head 1.

The print head 1 includes a light-emitting unit 10 and a rod lens array 12. The light-emitting unit 10 includes a transparent substrate 11. The transparent substrate 11 is, for example, a glass substrate that passes light. For example, a plurality of light-emitting element arrays 13 including, for example, a plurality of light-emitting elements such as LEDs or OLEDs are formed on the transparent substrate 11. FIG. 1 illustrates an example in which two arrays of a first light-emitting element array 13L1 and a second light-emitting element array 13L2 are formed to be parallel with each other. In the embodiment, a case in which the print head 1 includes a plurality of light-emitting element arrays 13 is described, but a case in which the print head 1 includes a single light-emitting element array 13 is also assumed.

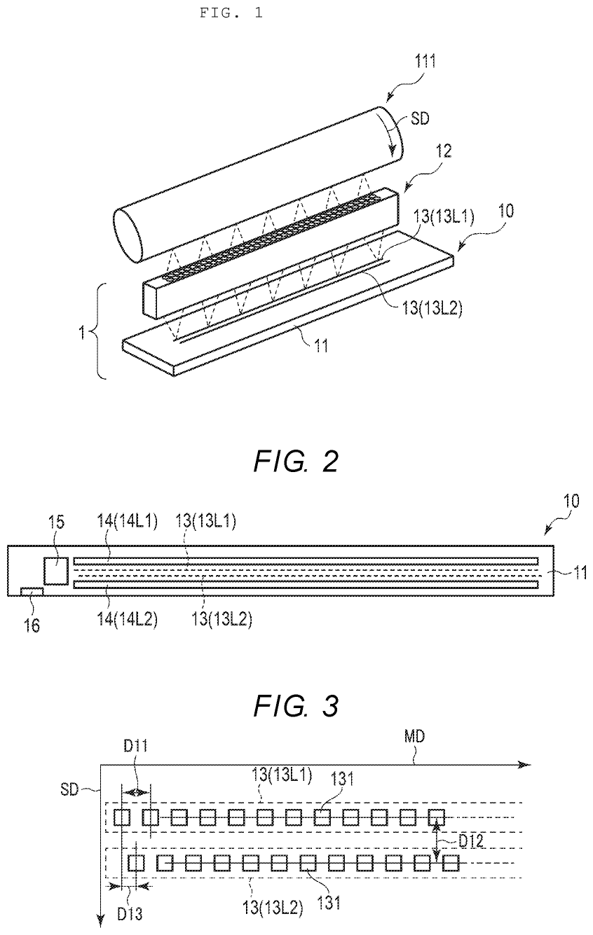

FIG. 2 is a diagram illustrating an example of the transparent substrate included in the print head according to the embodiment. As illustrated in FIG. 2, the two light-emitting element arrays 13 (the first light-emitting element array 13L1 and the second light-emitting element array 13L2) are formed in the center of the transparent substrate 11 in the longitudinal direction of the transparent substrate 11. Near the light-emitting element arrays 13, DRV circuit arrays 14 (a first DRV circuit array 14L1 and a second DRV circuit array 14L2) that drive each light-emitting element (cause each light-emitting element to emit light) are formed.

In FIG. 2, the DRV circuit arrays 14 that drive each light-emitting element (cause each light-emitting element to emit light) are disposed on both sides of the two light-emitting element arrays 13, but the DRV circuit arrays 14 may be disposed on one side of the two light-emitting element arrays 13.

An integrated circuit (IC) 15 is disposed at an end of the transparent substrate 11. The transparent substrate 11 includes a connector 16. The connector 16 electrically connects the print head 1 to a control system of a printer, a printmachine, or a multi-functional peripheral. This connection enables power supply, head control, image data transmission, and the like. A substrate for sealing the light-emitting element arrays 13, the DRV circuit arrays 14, and the like so as not to be in contact with the outside air is mounted on the transparent substrate 11. When it is difficult to mount the connector on the transparent substrate, a flexible printed circuit (FPC) may be connected to the transparent substrate to be electrically connected to the control system.

FIG. 3 is a diagram illustrating an example of the light-emitting element arrays (two-line head) according to the embodiment. As illustrated in FIG. 3, each light-emitting element array 13 (the first light-emitting element array 13L1 and the second light-emitting element array 13L2) includes a plurality of light-emitting elements 131 arranged in a main scanning direction MD perpendicular to a moving direction (the sub-scanning direction SD) of the photosensitive drum 111. That is, the plurality of light-emitting elements 131 forming a first line of light-emitting element arrays 13 and the plurality of light-emitting elements 131 forming a second line of light-emitting element arrays 13 are parallel to each other in the main scanning direction MD.

The light-emitting element 131 has, for example, a 20 μm square shape. A disposition interval D11 of the light-emitting elements 131 is, for example, a pitch of about 42.3 μm which is a resolution of 600 dpi. That is, the plurality of light-emitting elements 131 included in the second light-emitting element array 13L2 are disposed to deviate from the plurality of light-emitting elements included in the first light-emitting element array 13L1 at a constant interval (the disposition interval D11) in the main scanning direction.

The first line of light-emitting element arrays 13 and the second line of light-emitting element arrays 13 are disposed with an interval of a distance D12 in the sub-scanning direction SD. Further, each light-emitting element 131 forming the first line of light-emitting element arrays 13 and each light-emitting element 131 forming the second line of light-emitting element arrays 13 are disposed to deviate at a predetermined pitch D13 in the main scanning direction MD. For example, the predetermined pitch D13 is ½ of the disposition interval D11. Thus, the two light-emitting element arrays 13 are disposed in a zigzag form.

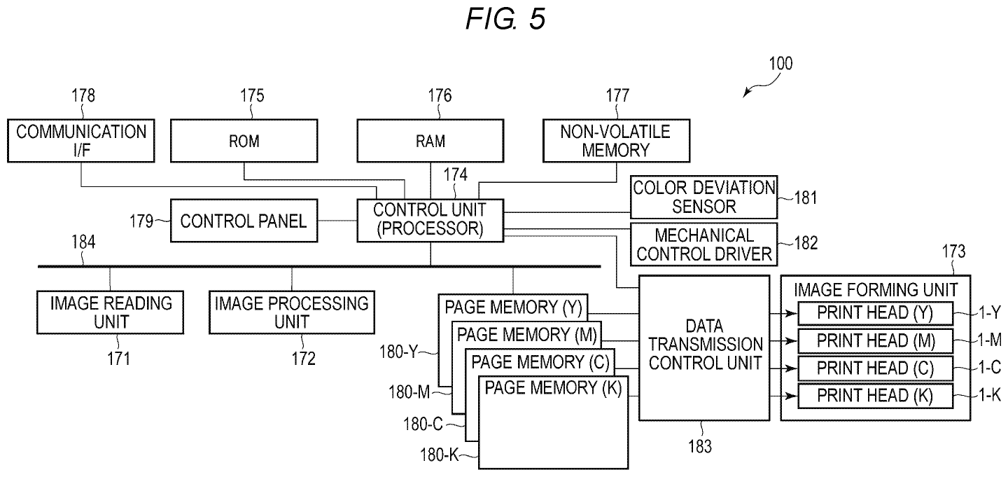

When the light-emitting elements of the first and second lines of light-emitting element arrays 13 emit light at the same timing, an exposure pattern with a zigzag form is formed on the photosensitive drum 111. When the upstream side in the moving direction of the photosensitive drum 111 is referred to as the first line and the downstream side thereof is referred to as the second line, a control unit to be described below (a control unit 174 in FIG. 5) causes the first line of light-emitting element arrays 13 and the second line of light-emitting element arrays 13 to emit light at different timings in accordance with a moving speed of the photosensitive drum 111 and the distance D12. That is, the control unit 174 delays a light emission timing of the second line of light-emitting element arrays 13 by a certain time with respect to the first line of light-emitting element array 13 in accordance with the moving speed of the photosensitive drum 111 and the distance D12. In other words, the control unit 174 outputs first light-emitting element image data and second light-emitting element image data to the first line of the light-emitting element arrays 13 and the second line of the light-emitting element arrays 13, respectively, at different timings in accordance with the moving speed of the photosensitive drum 111 and the distance D12. Here, the first light-emitting element image data and the second light-emitting element image data correspond to image data equivalent to one line in the main scanning direction. Thus, a latent image is formed on the photosensitive drum with a resolution of 1200 dpi.

In this way, the control unit 174 controls the light emission timings (image data transmission timings) of the plurality of light-emitting element arrays 13, thereby achieving densification of an image. In the case of two light-emitting element arrays 13, densification of an image can be two times the density of the light-emitting elements 131 per line. In the case of n (where n 3, n is an integer) light-emitting element arrays 13, densification of an image can be n times the density of the light-emitting elements 131 per line.

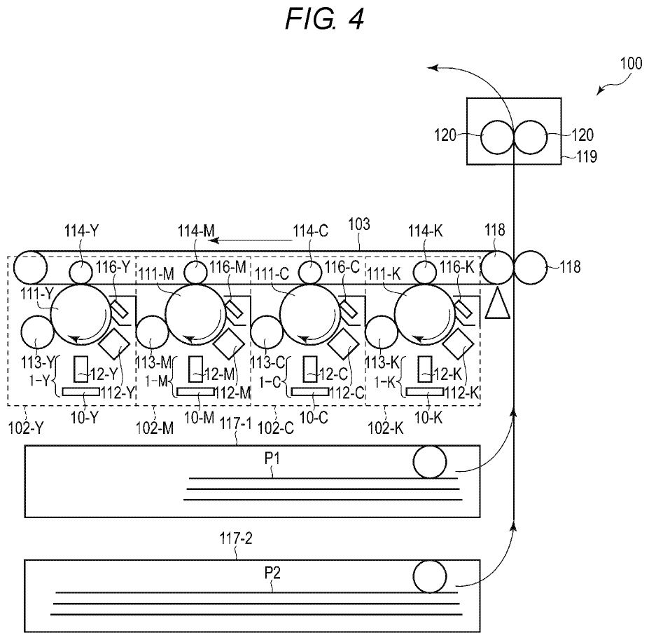

FIG. 4 is a diagram illustrating an example of the image forming apparatus to which the print head according to the embodiment is applied. FIG. 4 illustrates an example of a quadruple tandem type of color image forming apparatus, but the print head 1 according to the embodiment can also be applied to a monochromic image forming apparatus.

As illustrated in FIG. 4, for example, the image forming apparatus 100 includes an image forming unit 102-Y that forms a yellow (Y) image, an image forming unit 102-M that forms a magenta (M) image, an image forming unit 102-C that forms a cyan (C) image, and an image forming unit 102-K that forms a black (K) image. The image forming units 102-Y, 102-M, 102-C, and 102-K form yellow, cyan, magenta, and black images, respectively, to transfer the images to a transfer belt 103. In this way, a full-color image can be formed on the transfer belt 103.

The image forming unit 102-Y includes an electrostatic charger 112-Y, a print head 1-Y, a development unit 113-Y, a transfer roller 114-Y, and a cleaner 116-Y in the periphery of a photosensitive drum 111-Y. The image forming units 102-M, 102-C, and 102-K have the same configuration.

In FIG. 4, a sign “-Y” is assigned to the configuration of the image forming unit 102-Y that forms a yellow (Y) image. A sign “-M” is assigned to the configuration of the image forming unit 102-M that forms a magenta (M) image. A sign “-C” is assigned to the configuration of the image forming unit 102-C that forms a cyan (C) image. A sign “-K” is assigned to the configuration of the image forming unit 102-K that forms a black (K) image.

The electrostatic chargers 112-Y, 112-M, 112-C, and 112-K evenly charge photosensitive drums 111-Y, 111-M, 111-C, and 111-K, respectively. The print heads 1-Y, 1-M, 1-C, and 1-K form electrostatic latent images on the photosensitive drums 111-Y, 111-M, 111-C, and 111-K by exposing the photosensitive drums 111-Y, 111-M, 111-C, and 111-K, respectively, through light emission of the light-emitting elements 131 of the first light-emitting element array 13L1 and the second light-emitting element array 13L2. The development units 113-Y, 113-M, 113-C, and 113-K attach (develop) yellow toner, magenta toner, cyan toner, and black toner to the electrostatic latent images on the photosensitive drums 111-Y, 111-M, 111-C, and 111-K, respectively.

The transfer rollers 114-Y, 114-M, 114-C, and 114-K transfer the toner images developed to the photosensitive drums 111-Y, 111-M, 111-C, and 111-K to the transfer belt 103. The cleaners 116-Y, 116-M, 116-C, and 116-K clean the toner not transferred and remaining on the photosensitive drums 111-Y, 111-M, 111-C, and 111-K and waits for subsequent image formation.

A sheet (image formation medium) P1 with a first size (small size) is stored in a sheet cassette 117-1 which is a sheet supply unit. A sheet (image formation medium) P2 with a second size (large size) is stored in a sheet cassette 117-2 which is a sheet supply unit.

The toner images are transferred from the transfer belt 103 to the sheet P1 or P2 extracted from the sheet cassette 117-1 or 117-2 by a pair of transfer rollers 118 which are transfer units. The sheet P1 or P2 to which the toner images are transferred is heated and pressurized by a fixing roller 120 of a fixing unit 119. The toner images are firmly fixed to the sheet P1 or P2 through the heating and pressurization by the fixing roller 120. By repeating the above processing operation, the image forming operation is consecutively performed.

FIG. 5 is a block diagram illustrating an example of the control system of the image forming apparatus according to the embodiment. As illustrated in FIG. 5, the image forming apparatus 100 includes an image reading unit 171, an image processing unit 172, an image forming unit 173, a control unit 174, a read-only memory (ROM) 175, a random access memory (RAM) 176, a non-volatile memory 177, a communication interface (I/F) 178, a control panel 179, page memories 180-Y, 180-M, 180-C, and 180-K, a color deviation sensor 181, and a mechanical control driver 182. The image forming unit 173 includes the image forming units 102-Y, 102-M, 102-C, and 102-K.

The ROM 175, the RAM 176, the non-volatile memory 177, the communication I/F 178, the control panel 179, the color deviation sensor 181, the mechanical control driver 182 and a data transmission control unit 183 are connected to the control unit 174.

The image reading unit 171, the image forming unit 172, the control unit 174, and the page memories 180-Y, 180-M, 180-C, and 180-K are connected to an image data bus 184. The data transmission control unit 183 is connected to the page memories 180-Y, 180-M, 180-C, and 180-K. The print heads 1-Y, 1-M, 1-C, and 1-K are connected to the data transmission control unit 183 in accordance with each signal. The data transmission control unit 183 is a unit that serves a shift operation for an image formation region to be described below in response to an instruction of the control unit 174.

The control unit 174 is configured with one or more processors and controls operations (including a light emitting operation of the print head to be described below) such as image reading, image processing, and image forming in accordance with various programs stored in at least one of the ROM 175 and the non-volatile memory 177. The data transmission control unit 183 includes a line memory and transmits data transmitted from the page memories 180-Y, 180-M, 180-C, and 180-K to the light-emitting elements of the print heads 1-Y, 1-M, 1-C, and 1-K in response to an instruction of the control unit 174.

The ROM 175 stores various programs or the like necessary for controlling the control unit 174. The various programs include a light emission control program for the print heads.

The RAM 176 temporarily stores data necessary for controlling the control unit 174. The non-volatile memory 177 stores updated programs, various parameters, and the like. The non-volatile memory 177 may store some or all of the various programs.

The mechanical control driver 182 controls an operation of a motor or the like necessary in printing in response to an instruction of the control unit 174. The communication I/F 178 outputs various kinds of information to the outside and inputs various kinds of information from the outside. For example, the image forming apparatus 100 prints image data input via the communication I/F by a printing function. The control panel 179 receives input operations from a user and a serviceman.

The image reading unit 171 optically reads an image of a document, acquires image data, and outputs the image data to the image processing unit 172. The image processing unit 172 performs various kinds of image processing (including correction) on the image data input via the communication I/F 178 or the image data from the image reading unit 171. The page memories 180-Y, 180-M, 180-C, and 180-K store the image data processed by the image processing unit 172. The control unit 174 controls the image data on the page memories 180-Y, 180-M, 180-C, and 180-K to fit print positions or the print heads. The image forming unit 173 forms images based on the image data stored in the page memories 180-Y, 180-M, 180-C, and 180-K. The image forming unit 173 includes the print heads 1-Y, 1-M, 1-C, and 1-K.

The control unit 174 inputs test patterns to the page memories 180-Y, 180-M, 180-C, and 180-K to form the test patterns. The color deviation sensor 181 detects the test patterns formed on the transfer belt 103 and outputs a detection signal to the control unit 174. The control unit 174 can recognize a positional relation between the test patterns of each color from an input of the color deviation sensor 181.

The control unit 174 selects the sheet cassette 117-1 or 117-2 feeding a sheet on which an image is formed through the mechanical control driver 182.

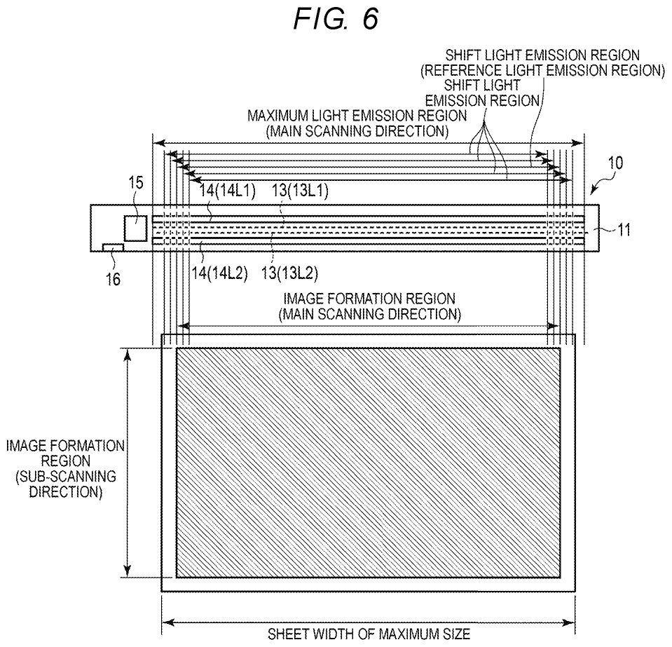

FIG. 6 is a diagram illustrating an example of a relation between the light emission region (a main scanning width) and an image formation region of the print head according to the embodiment. As illustrated in FIG. 6, a maximum light emission region (main scanning width) is formed to correspond to the light-emitting element arrays 13 of the print head 1. That is, a space between the light-emitting element at the left end of the first light-emitting element array 13L1 and the light-emitting element at the right end of the second light-emitting element array 13L2 is equivalent to the maximum light emission region.

As illustrated in FIG. 6, an image formation region (main scanning direction×sub-scanning direction) is defined for a sheet with a maximum size received in the image forming apparatus 100. A relation among the maximum light emission region, a sheet width of the maximum size, and the image formation region in the main scanning direction is the following magnitude relation.

The magnitude relation: the maximum light emission region the sheet width of the maximum size>the image formation region. That is, the image formation region has a degree of freedom set in a range which does not exceed the maximum light emission region (the sheet width of the maximum size). That is, a plurality of image formation regions can be set.

Light emission of the light-emitting elements located in the image formation region is controlled based on pixel information of the image data transmitted from the data transmission control unit 183. As described above, the length of the image formation region in the main scanning direction is shorter than the length of the maximum light emission region in the main scanning direction. That is, by utilizing the maximum light emission region, the control unit 174 can form an image at any position in the main scanning direction by setting an image formation region at any position within the range of the maximum light emission region (the sheet width of the maximum size) using the data transmission control unit 183. In other words, by utilizing the maximum light emission region, the image formation region can be shifted right or left in the main scanning direction, and thus a load of the light-emitting elements (a load concentrated on specific light-emitting elements) is shifted right or left, that is, is distributed, by shifting the image formation region.

Here, a light emission region corresponding to the image formation region is referred to as a shift light emission region. As illustrated in FIG. 6, a plurality of shift light emission regions are at any positions within the maximum light emission region. A light emission region located in the center of a sheet in the shift light emission region is particularly referred to as a reference light emission region. The control unit 174 changes the selection of the shift light emission region in order to shift the image formation region. When the control unit 174 selects the reference light emission region, an image is formed in the center of the sheet (in the main scanning direction).

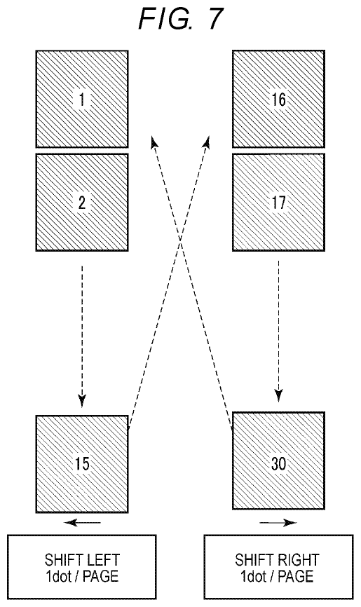

FIG. 7 is a diagram illustrating an example of image shifting by the image forming apparatus according to the embodiment. For example, when only a specific light emission region is used highly frequently within the maximum light emission region corresponding to the light-emitting element arrays 13 of the print heads 1, the amount of light of the light-emitting elements in the specific light emission region decreases, the difference between the amount of light of the light-emitting elements in the specific light emission region and the amount of light of the light-emitting elements in a region other than the specific light emission region increases, and thus the density irregularity or the like is conspicuous.

Accordingly, the control unit 174 shifts a light emission region for forming an image in the main scanning direction (the direction of the light-emitting element arrays 13) within the maximum light emission region in accordance with printing of images in a unit of predetermined prints (for example, a unit of one print) based on the image data. Therefore, the control unit 174 selects one light emission region from the plurality of shift light emission regions and transmits the information to the data transmission control unit 183. The data transmission control unit 183 transmits pixel information of the image data toward each light-emitting element 131 in the selected light emission region (hereinafter referred to as a “selected shift light emission region”) and controls light emission of the selected shift light emission region. The relation between the maximum light emission region and each shift light emission region is as illustrated in FIG. 6. The length of each shift light emission region in the main scanning direction corresponds to the length (width) of the image in the main scanning direction. For example, each shift light emission region is shifted right or left by one light-emitting element in the main scanning direction.

The control unit 174 selects one light emission region sequentially from the plurality of shift light emission regions within the maximum light emission region and the data transmission control unit 183 transmits the pixel information of the image data to each light-emitting element 131 in the sequentially selected shift light emission region, as illustrated in FIG. 7, so that images can be formed while shifting the shift light emission region by 1 dot to the left for each printing, for example, from first to fifteenth prints in the main scanning direction within the maximum light emission region. The images can be formed while shifting the shift light emission region to the right by 1 dot for each printing from sixteenth to thirtieth prints in the main scanning direction within the maximum light emission region. The shift light emission region may be shifted by 2 dots or 3 dots. For example, in the case of 1200 dot/inch (dpi), a shift amount of 1 dot is equivalent to about 20 μm, a maximum of 0.3 mm can be shifted to the left, and a maximum of 0.3 mm can be shifted to the right. When a shift amount is 1 dot, the image before the shifting and the image after the shifting are not visually distinguished from each other. Even for the maximum shift amount, the image before the shifting and the image after the shifting are rarely visually distinguished from each other.

At the time of printing of a color image, the control unit 174 selects one shift light emission region among the plurality of shift light emission regions of each print head 1 (the print heads 1-Y, 1-M, 1-C, and 1-K) corresponding to each color in accordance with printing of a color image in a unit of one print. The data transmission control unit 183 transmits pixel information stored in each page memory 180 (the page memories 180-Y, 180-M, 180-C, and 180-K) to each light-emitting element 13 in the selected shift light emission region of each print head 1 and controls the light emission of the selected shift light emission region of each print head 1. The shift light emission region selected by each print head 1 is a region having a corresponding positional relation. For example, when the control unit 174 selects the reference light emission region (center) of the print head 1-Y, the reference light emission region (center) is also selected for the other print heads 1-M, 1-C, and 1-K. When the shift light emission region located left by 1 dot from the reference light emission region of the print head 1-Y is selected, the shift light emission region located left by 1 dot from the reference light emission region is selected for the other print heads 1-M, 1-C, and 1-K. The image forming unit 173 forms a color image positioned for each color (shifted by the same amount for each color) through light emission of the selected shift light emission region at the position corresponding to each print head 1.

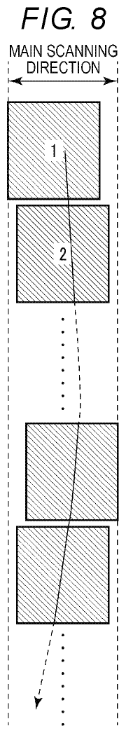

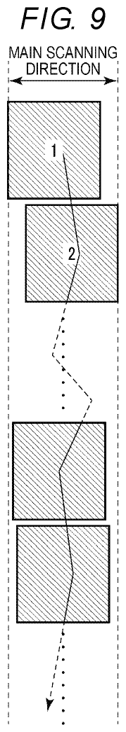

FIG. 8 is an explanatory diagram illustrating a concept of consecutive shifting by the image forming apparatus according to the embodiment, and FIG. 9 is an explanatory diagram illustrating a concept of random shifting by the image forming apparatus according to the embodiment. As illustrated in FIG. 8, consecutive shifting by the control unit 174 and the data transmission control unit 183 is a process of shifting an image to the right (or the left) in a unit of a predetermined number of dots (for example, a unit of one dot) in the main scanning direction, and shifting the image to the left (or the right) in the main scanning direction in a unit of the predetermined number of dots after the image is shifted to the right (or the left) limit. That is, the consecutive shifting is a process of sequentially selecting one light emission region from the plurality of adjacent light emission regions. As illustrated in FIG. 9, random shifting by the control unit 174 and the data transmission control unit 183 is a process of randomly shifting an image in the main scanning direction. That is, the random shifting is a process of randomly selecting one light emission region from the plurality of light emission regions. In order to realize the consecutive shifting or the random shifting, as described above, the control unit 174 selects a shift light emission region, the data transmission control unit 183 transmits image information, and the image forming unit 173 forms images (forms color images). At the time of forming a color image, it is needless to say that the same shift light emission region is selected in each head in either the consecutive shifting or the random shifting.

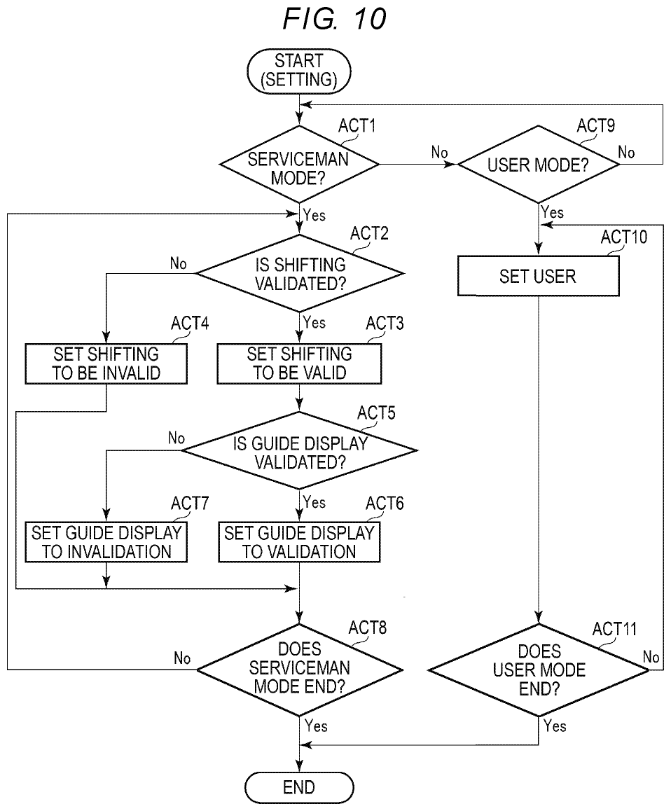

FIG. 10 is a flowchart illustrating a setting example of shifting by the image forming apparatus according to the embodiment. The image forming apparatus 100 receives validation or invalidation setting of shifting. For example, when a serviceman designates a serviceman mode via the control panel 179 of the image forming apparatus 100, the control unit 174 receives the serviceman mode (YES in ACT1).

Further, when the serviceman designates shifting as being valid via the control panel 179 (YES in ACT2), the control unit 174 sets the shifting to be valid (ACT3) and the non-volatile memory 177 stores the validation setting of the shifting. For example, as the shifting, first shifting, second shifting, and third shifting can be selected and set to be valid. The first shifting, the second shifting, and the third shifting will be described in detail later.

When the serviceman sets the shifting as being invalid via the control panel 179 (NO in ACT2), the control unit 174 sets the shifting to be invalid (ACT4) and the non-volatile memory 177 stores the invalidation setting of the shifting.

When the serviceman designates a guide display related to the shifting as being valid via the control panel 179 (YES in ACT5) after the shifting is set to be valid, the control unit 174 sets the guide display of the shifting to be valid (ACT6) and the nonvolatile memory 177 stores the validation setting of the guide display of the shifting. Thus, when the shifting is set to be valid or the shifting functions, the control panel 179 displays a guide related to the shifting.

Further, when the serviceman designates the guide display of the shifting to be invalid via the control panel 179 (NO in ACT5), the control unit 174 sets the guide display of the shifting to be invalid (ACT7) and the non-volatile memory 177 stores the invalidation setting of the guide display of the shifting. Thus, even when the shifting is set to be valid or the shifting functions, the control panel 179 does not display the guide related to the shifting.

When the control unit 174 receives the end of the serviceman mode (YES in ACT8), the control unit 174 ends the setting. Conversely, when the control unit 174 receives a user mode (YES in ACT9) rather than the serviceman mode (NO in ACT1), the control unit 174 receives various kinds of setting in the user mode and performs the same operations of ACT2 to ACT7 in the above-described serviceman mode (ACT10). When the control unit 174 receives the end of the user mode (YES in ACT11), the control unit 174 ends the setting.

In the embodiment, a case in which the validation or invalidation of the shifting is set in the serviceman mode is described. However, the validation or invalidation of the shifting may be set in the user mode or the shifting may be set to be valid at the time of shipment of the image forming apparatus and to make the setting impossible to change. As an advantage of setting the shifting to be valid or invalid in the serviceman mode, it is possible to obtain an advantageous effect that density irregularity or the like is not conspicuous when the shifting functions without imposing a burden of setting on a user and without making the user aware of the setting. As an advantage of setting the shifting to be valid or invalid in the user mode, it is possible to obtain an advantageous effect that an intention of the user can be reflected quickly, and thus density irregularity or the like is not conspicuous when the shifting functions. As an advantage of setting the shifting to be valid at the time of shipment and making the setting impossible to change, it is possible to obtain an advantageous effect that density irregularity or the like is not conspicuous when the shifting functions without imposing a burden of setting on a serviceman or a user.

As the image forming apparatus has a guide display function for shifting, the user can visually recognize that the shifting is validated or the shifting functions. For example, a shift amount of 1 dot is about 20 μm and an image before the shifting is rarely visually distinguished from the image after the shifting. Thus, because of the slight shifting, there is no problem in practical use as a printing result even when the shifting is performed. On the other hand, whether or not the shifting is performed can hardly be determined from a printing result. Through the guide display of the shifting, the user can check that the shifting is validated or the shifting functions.

In the embodiment, a case in which the guide display of the shifting is set to be valid or invalid will be described, but the guide display of the shifting is not essential. An image forming apparatus having no guide display function of shifting so that the user is not aware may be realized.

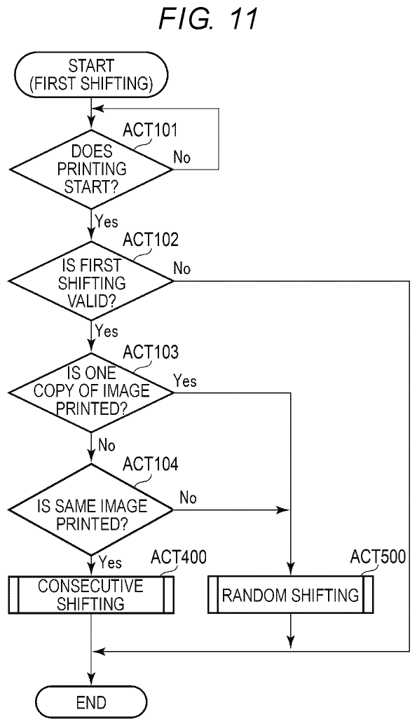

FIG. 11 is a flowchart illustrating an example of first shifting by the image forming apparatus according to the embodiment. The control unit 174, the communication I/F 178, the image reading unit 171, the data transmission control unit 183, and the like of the image forming apparatus are included in constituent elements of the light emission control device that controls light emission of the print head 1.

For example, the communication I/F 178 of the image forming apparatus 100 is an acquisition unit that acquires image data for printing. When the communication I/F 178 receives the image data for printing, the control unit 174 gives an instruction to start printing (YES in ACT101). Alternatively, the image reading unit 171 of the image forming apparatus 100 is an acquisition unit that acquires image data for printing. When the image reading unit 171 reads an image from a document and acquires the image data for printing, the control unit 174 gives an instruction to start printing (YES in ACT101).

When the first shifting is set to be valid (YES in ACT102), and the printing is not the printing of one print of an image (NO in ACT103) but the printing of a plurality of prints of the same image (YES in ACT104), the control unit 174 performs the consecutive shifting (ACT400). The control panel 179 displays a guide related to the shifting during a period in which the guide display of the shifting is set to be valid and displays a guide related to the consecutive shifting during a period in which the consecutive shifting functions.

When the first shifting is set to be valid (YES in ACT102), and the printing is the printing of one print of an image (YES in ACT103) or the printing of plurality of prints of different images (NO in ACT104), the control unit 174 performs the random shifting (ACT500). The control panel 179 displays a guide related to the shifting during a period in which the guide display of the shifting is set to be valid and displays a guide related to the random shifting during a period in which the random shifting functions.

For example, the following four printing forms are assumed: a first printing form: printing of one print of one image (one-image printing); a second printing form: printing of a plurality of prints of one image (consecutive printing of the same image); a third printing form: printing of one print of a plurality of images (consecutive printing of different images); and a fourth printing form: printing of a plurality of prints of a plurality of images (repetition of consecutive printing of different images). For example, the control unit 174 determines that designation of the second printing form is consecutive shifting and determines that designation of the first, third, and fourth printing forms are random shifting.

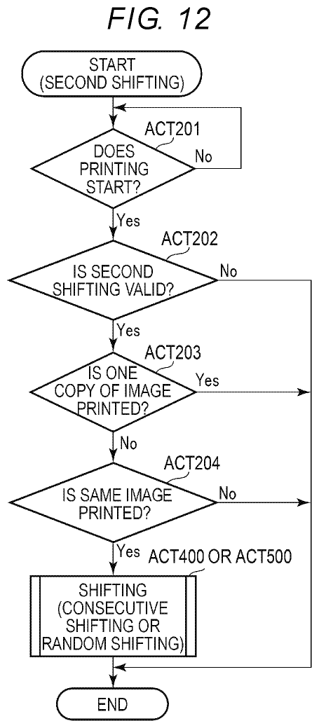

FIG. 12 is a flowchart illustrating an example of second shifting by the image forming apparatus according to the embodiment. When the control unit 174 gives an instruction to start printing (YES in ACT201), the second shifting is set to be valid (YES in ACT202), the printing is not the printing of one print of an image (NO in ACT203) but the printing of a plurality of prints of the same image (YES in ACT204), the control unit 174 performs the shifting (the consecutive shifting or the random shifting) (ACT400 or ACT500). The control unit 174 selects the consecutive shifting or the random shifting in accordance with the preliminary setting. The control panel 179 displays a guide related to the shifting during a period in which the guide display of the shifting is set to be valid and displays a guide related to the consecutive shifting or the random shifting during a period in which the consecutive shifting or the random shifting functions.

When the second shifting is set to be invalid (NO in ACT202), or the printing is the printing of one print of an image (YES in ACT203), or the printing is the printing of a plurality of different images (NO in ACT204), the control unit 174 does not perform the shifting (the consecutive shifting or the random shifting).

The printing of a plurality of prints of the same image has a high possibility to results in a decrease in the amount of light of some of the light-emitting elements of the print head, and thus density irregularity is conspicuous. Accordingly, in the second shifting, the consecutive shifting or the random shifting is applied to the printing of plural prints of the same image (the second printing form) and the consecutive shifting or the random shifting is not applied to the other printing. Accordingly, the shifting can be applied to printing jobs which has a high possibility to have a conspicuous density irregularity or the like.

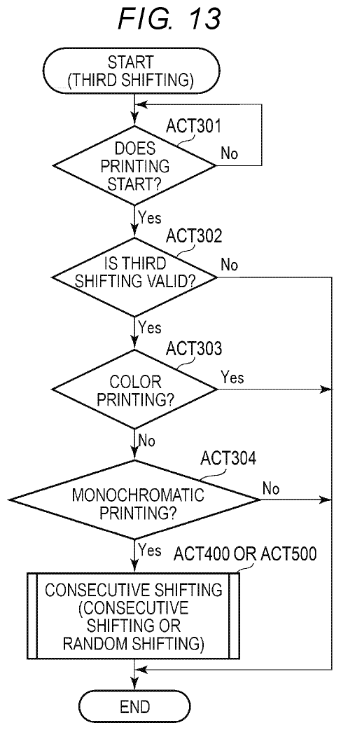

FIG. 13 is a flowchart illustrating an example of third shifting by the image forming apparatus according to the embodiment. When the control unit 174 gives an instruction to start printing (YES in ACT301), the third shifting is set to be valid (YES in ACT302), the printing is not color printing (NO in ACT303) but monochromatic printing (YES in ACT304), the control unit 174 performs the shifting (the consecutive shifting or the random shifting) (ACT400 or ACT500). The control panel 179 displays a guide related to the shifting during a period in which the guide display of the shifting is set to be valid and displays a guide related to the consecutive shifting or the random shifting during a period in which the consecutive shifting or the random shifting functions.

When the third shifting is set to be invalid (NO in ACT302) or the printing is color printing (YES in ACT303), the control unit 174 does not perform the shifting (the consecutive shifting or the random shifting).

In the monochromatic printing, density irregularity or the like is more likely to be conspicuous than in the color printing. Accordingly, in the third shifting, the consecutive shifting or the random shifting is applied to the monochromatic printing which has a high possibility to have a conspicuous density irregularity or the like, and the consecutive shifting or the random shifting is not applied to the color printing. Thus, the shifting can be applied to printing jobs which has a high possibility to have a conspicuous density irregularity or the like.

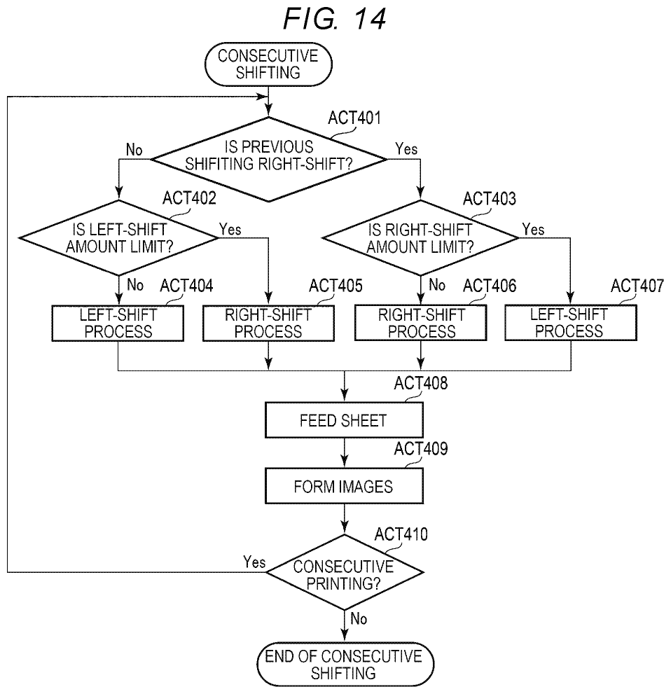

FIG. 14 is a flowchart illustrating an example of consecutive shifting by the image forming apparatus according to the embodiment. When the control unit 174 determines that the previous shifting is left shifting (NO in ACT401) and a left-shift amount does not reach a limit (NO in ACT402), the control unit 174 performs left shifting (ACT404). Accordingly, the control unit 174 selects a shift light emission region located left by one unit from the shift light emission region selected in the previous shifting, feeds a sheet (ACT408), and forms images (ACT409). That is, the data transmission control unit 183 transmits the image data to the selected shift light emission region as a target and the print heads 1-Y, 1-M, 1-C, and 1-K of the image forming unit 173 form images through light emission of the selected shift light emission region based on the image data.

When the left-shift amount reaches the limit (YES in ACT402), the control unit 174 performs right shifting (ACT405). Accordingly, the control unit 174 selects a shift light emission region located right by one unit from the shift light emission region selected in the previous shifting, feeds a sheet (ACT408), and forms images (ACT409).

When the control unit 174 determines that the previous shifting is the right shifting (YES in ACT401) and a right-shift amount does not reach a limit (NO in ACT403), the control unit 174 performs the right shifting (ACT406). Accordingly, the control unit 174 selects a shift light emission region located right by one unit from the shift light emission region selected in the previous shifting, feeds a sheet (ACT408), and forms images (ACT409).

Further, when the right shift amount reaches the limit (YES in ACT403), the control unit 174 performs the left shifting (ACT407). Accordingly, the control unit 174 selects a shift light emission region located left by one unit from the shift light emission region selected in the previous shifting, feeds a sheet (ACT408), and forms images (ACT409).

When the consecutive printing continues (YES in ACT410), the processes subsequent to ACT401 are repeated. When the consecutive printing ends (NO in ACT410), the consecutive shifting ends.

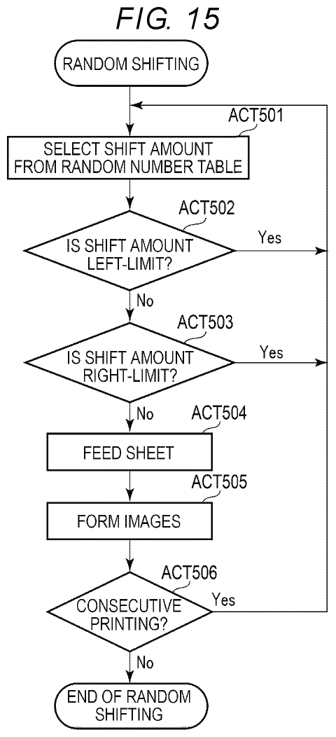

FIG. 15 is a flowchart illustrating an example of random shifting by the image forming apparatus according to the embodiment. When the control unit 174 selects a shift amount from a random number table stored in the non-volatile memory 177 or the like (ACT501), the shift amount does not reach a left limit (NO in ACT 502) and the shift amount does not reach a right limit (NO in ACT503), the control unit 174 performs shifting in accordance with the shift amount. Accordingly, the control unit 174 selects a shift light emission region in accordance with the shift amount, feeds a sheet (ACT504), and forms images (ACT506). That is, the data transmission control unit 183 transmits the image data to the selected shift light emission region as a target and the print heads 1-Y, 1-M, 1-C, and 1-K of the image forming unit 173 form images through light emission of the selected shift light emission region based on the image data.

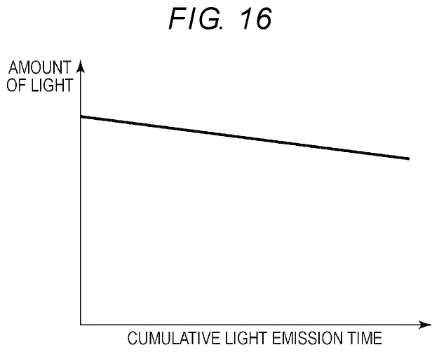

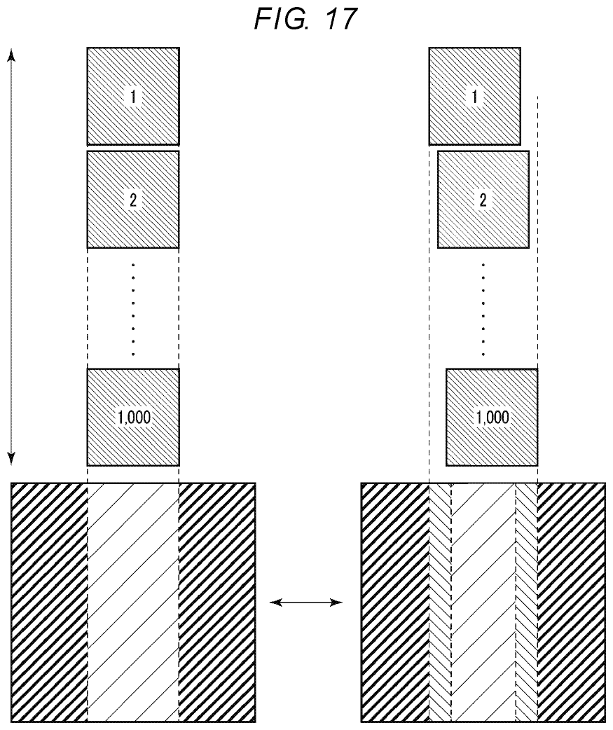

FIG. 16 is a diagram illustrating an example of a relation between a cumulative light emission time and an amount of light in each light-emitting element of the print head. FIG. 17 is a diagram illustrating a comparison example between an influence on density irregularity when printing multiple prints of the same image or same-size images without shifting and an influence on density irregularity when printing multiple prints of the same image or same-size images with shifting.

As illustrated in FIG. 16, it can be understood that an amount of light of the light-emitting elements of the print head decreases in accordance with the cumulative light emission time. Therefore, when multiple prints of the same image or same-size images are consecutively printed without shifting, the output of specific light-emitting elements decreases and a boundary of a density difference is conspicuous in some cases. Conversely, when the shifting is applied, a plurality of light emission regions to be shifted to the left or right within the maximum light emission region of the print head are selectively used despite consecutive printing of multiple prints of the same image or same-size images. Therefore, the boundary of the density difference can be vague, and thus density irregularity is not conspicuous.

While certain embodiments have been described, these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A light emission control device comprising:
an acquisition unit configured to acquire image data; and
a processor configured to:
select a respective light emission region from a plurality of light emission regions to be shifted in a direction of a light-emitting element array within a maximum light emission region corresponding to the light-emitting element array of a print head in accordance with printing of images in a unit of a predetermined number of prints based on the image data; and
control light emission of the respective light emission region based on the image data.

2. The light emission control device of claim 1, wherein the processor is configured to select the respective light emission region from the plurality of light emission regions in accordance with printing of the images in a unit of one print based on the image data.

3. The light emission control device of claim 1, wherein the processor is configured to select the respective light emission region from the plurality of light emission regions shifted by one light-emitting element.

4. The light emission control device of claim 1, wherein the processor is configured to sequentially select consecutive light emission regions from the plurality of light emission regions when a plurality of prints of the same image are printed and randomly select light emission regions from the plurality of light emission regions when a plurality of prints of different images are printed.

5. The light emission control device of claim 1, wherein the acquisition unit includes at least one of a communications interface or an image reading unit.

6. The light emission control device of claim 1, wherein the respective light emission region for a first sheet is different than the respective light emission region for a subsequent, second sheet.

7. An image forming apparatus comprising:
an acquisition unit configured to acquire image data;
a processor configured to:
select a respective light emission region from a plurality of light emission regions to be shifted in a direction of a light-emitting element array within a maximum light emission region corresponding to the light-emitting element array of a print head in accordance with printing of images in a unit of a predetermined number of prints based on the image data; and
control light emission of the respective light emission region based on the image data; and
an image forming unit including the print head, the image forming unit configured to form the images through the light emission of the light-emitting element array of the print head.

8. The image forming apparatus of claim 7, wherein the print head includes a plurality of print heads for forming a color image, and wherein the processor is configured to select the same light emission region for each of the plurality of print heads corresponding to each color.

9. The image forming apparatus of claim 7, wherein the processor is configured to select the respective light emission region from the plurality of light emission regions in accordance with printing of the images in a unit of one print based on the image data.

10. The image forming apparatus of claim 7, wherein the processor is configured to select the respective light emission region from the plurality of light emission regions shifted by one light-emitting element.

11. The image forming apparatus of claim 7, wherein the processor is configured to sequentially select consecutive light emission regions from the plurality of light emission regions when a plurality of prints are printed.

12. The image forming apparatus of claim 7, wherein the processor is configured to randomly select light emission regions from the plurality of light emission regions when a plurality of prints are printed.

13. The image forming apparatus of claim 7, wherein the acquisition unit includes at least one of a communications interface or an image reading unit.

14. The image forming apparatus of claim 7, wherein the respective light emission region for a first sheet is different than the respective light emission region for a subsequent, second sheet.

15. A method for controlling a print head of a printing apparatus, the method comprising:
receiving image data that indicates a plurality of sheets of paper are to be printed;
selecting a first light emission region of the print head, wherein the print head includes a light-emitting element array, wherein the light-emitting element array has a maximum light emission region, and wherein the first light emission region is only a first portion of the maximum light emission region;
controlling light emission from the light-emitting element array within the first light emission region based on the image data to facilitate printing a first sheet of paper of the plurality of sheets of paper;
selecting a second light emission region of the print head that is (i) within and only a second portion the maximum light emission region and (ii) at least partially shifted relative to the first light emission region; and
controlling light emission from the light-emitting element array within the second light emission region based on the image data to facilitate printing a second sheet of paper of the plurality of sheets of paper.

16. The method of claim 15, wherein the second light emission region is shifted relative to the first light emission region according to a consecutive shifting procedure.

17. The method of claim 16, wherein the consecutive shifting procedure includes shifting light emission regions by a predetermined number of lights of the light-emitting element array in a first direction for each subsequent sheet of paper of the plurality of sheets of paper printed by the printing apparatus until a first shift limit is reached.

18. The method of claim 17, wherein, in response to the first shift limit being reached, the consecutive shifting procedure further includes shifting the light emission regions by the predetermined number of lights of the light-emitting element array in an opposing second direction for each subsequent sheet of paper of the plurality of sheets of paper printed by the printing apparatus until a second shift limit is reached.

19. The method of claim 15, wherein the second light emission region is shifted relative to the first light emission region according to a random shifting procedure.

20. The method of claim 19, wherein the random shifting procedure includes shifting light emission regions by a random number of lights of the light-emitting element array in a first direction or an opposing second direction for each subsequent sheet of paper of the plurality of sheets of paper printed by the printing apparatus.
